(19) United States
(12) Patent Application Publication
(10) Pub. No.: US 2015/0033102 A1
(43) Pub. Date: Jan. 29, 2015

(54) DIRECT PRESENTATIONS FROM CONTENT COLLECTIONS

(71) Applicant: Evernote Corporation, Redwood City, CA (US)

(72) Inventors: Zdzislaw Pawel Losvik, Stafa (CH); Jack Hirsch, San Francisco, CA (US); Ruben Bakker, Sursee (CH); Phil Constantinou, San Francisco, CA (US); Phil Libin, San Jose, CA (US); Daniel Nicolae, Berlin (DE); Naomi Ionita, San Francisco, CA (US)

(21) Appl. No.: 14/308,025

(22) Filed: Jun. 18, 2014

Related U.S. Application Data
(60) Provisional application No. 61/858,660, filed on Jul. 26, 2013.

(51) Int. Cl. G06F 17/21; G06F 3/0482; G06F 3/0481; G06F 3/0485

(52) U.S. Cl. CPC G06F 17/212; G06F 3/0485; G06F 3/0482; G06F 3/04812
USPC 715/202

(57) ABSTRACT

Presenting content includes selecting a subset of content items from a content collection, where at least some of the subset of content items includes a plurality of objects selected from the group of categories consisting of: text, images, web clips, HTML clips, audio clips, video clips, links to external web content, document attachments, and multimedia attachments and includes displaying content items from the subset of content items on a presentation screen, where intelligent navigation facilitates scanning through objects included with each of the content items. The intelligent navigation may use a dedicated button, a keyboard shortcut and/or a multi-touch gesture for scanning through objects. The intelligent navigation may allow scrolling through objects by category. Presenting content may also include automatically forming a first cover note having a first table of contents listing titles of at least a first portion of the subset of content items and corresponding links thereto.

### CROSS-REFERENCE TO RELATED APPLICATIONS

This application claims priority to U.S. Prov. App. No. 61/858,660, filed Jul. 26, 2013, and entitled “DIRECT PRESENTATIONS FROM CONTENT COLLECTIONS,” which is incorporated herein by reference.

### TECHNICAL FIELD

This application is directed to the field of organization and presentation of information, and more particularly to the field of building and displaying instant presentations from notes and documents in individual and shared content collections.

### BACKGROUND OF THE INVENTION

Business, educational, cultural and many other types of presentations have long become an organic feature of a modern society. Many millions of presentations are made daily in corporate meeting rooms, classrooms, auditoria and are shared via online conferences and viewed by participants of real and virtual meetings on all types of devices and platforms.

In more than three decades since the start of development of mainframe computerized presentation techniques, the presentation industry has acquired numerous mass market software applications and online solutions. Microsoft PowerPoint, Apple Keynote, Open Office Impress, Prezi, SoftMaker Presentations and many other desktop, online and mobile applications are facilitating creation of presentations and their display to audience. Presentation software titles include hundreds of useful features for automated creation of custom layouts, text and image presentations, business graphics, charting, animations within and between components, visual effects, clip art libraries with access to online image and photo resources, various presentation modes, and many other characteristics.

Notwithstanding important changes in the ways people conduct business meetings, learn, and make decisions that are facilitated by the presentation industry, analysts and general public are extensively discussing challenges and even damaging effects of low quality presentations. By some estimates, a direct economic damage of improper presentations is measured in hundreds of millions of dollars per day, primarily because of a wasted time of meeting participants that suffer through overloaded and unsubstantial presentations.

Part of an ongoing conflict between the traditional presentation culture and the needs of a fluid, information intense and time conscious contemporary business and personal lifestyles rests in the very nature of presentations. Pre-canned sets of materials built to convey a concrete idea in a relatively static manner and with an inevitable deferral because of the time taken to create and polish a presentation may risk staying behind an audience. As was pointed out in a recent media review of PowerPoint 2013, “The new Presenter view is impressive . . . but asking speakers to concentrate on their own screens could be the exact wrong thing to do.” Therefore, real-time updates to presentations may be highly desirable; but for traditional presentations, modifications typically occur as an offline activity and are virtually impossible during meetings; additionally, a presentation mode itself, once it is shared with an audience, is often a view-only mode where even the presenter does not have access to editing tools.

Growing use of personal and business content management systems, such as the Evernote Service and software developed by the Evernote Corporation of Redwood City, Calif., concentrates at the user fingertips information collected in different ways and in different formats. The formats include text, images, audio, web and document clips, handwritten notes created in integrated applications like Penultimate by Evernote, document and image markups built with Skitch by Evernote and with other similar software, attachments in a variety of layouts created by different applications, multiple content collections in the form of individual, shared and business-wide notebooks, multiple tagging, flexible search techniques, and augmented intelligence. All of the aspects of a content management system turn the system into an instant business collaboration and learning tool. The features of a content management system are in line with the dynamic, up-to-date business style, but may lack adequate presentation tools and workflows adapted to instantaneous changes in information and satisfying user needs for fast updates, including updates during presentations.

Accordingly, it is desirable to develop a presentation system and workflow for personal, shared and business oriented content collections allowing users to combine a high visual quality of presentations with easy and dynamic workflow for creating and presenting materials, simple navigation and an ability to edit presentations on the fly.

### SUMMARY OF THE INVENTION

According to the system described herein, presenting content includes selecting a subset of content items from a content collection, where at least some of the subset of content items includes a plurality of objects selected from the group of categories consisting of: text, images, web clips, HTML clips, audio clips, video clips, links to external web content, document attachments, and multimedia attachments and includes displaying content items from the subset of content items on a presentation screen, where intelligent navigation facilitates scanning through objects included with each of the content items. The intelligent navigation may use a dedicated button, a keyboard shortcut and/or a multi-touch gesture for scanning through objects. The intelligent navigation may allow scrolling through objects by category. Presenting content may also include automatically forming a first cover note having a first table of contents listing titles of at least a first portion of the subset of content items and corresponding links thereto. A presentation sequence for the content items may be directed by the first cover note in an order of selection of the content items. Clicking a link shown on the first cover note may cause a corresponding one of the content items to be opened. A second cover note, embedded in the first cover note, may be provided where the second cover note may include a second table of contents listing titles of at least a second portion of the subset of content items and corresponding links thereto, the second portion being different than the first portion. Each of the subset of content items that is edited while being displayed on the presentation screen may cause the presentation screen to be updated while being viewed. Editing functionality may be provided by at least one other device separate from a device controlling the presentation screen. Editing functionality may be provided by a plurality of other devices separate from the device controlling the presentation screen. Editing functionality may be provided by at least one other screen separate from the presentation screen. A presenter may control the at least one other screen. The presentation screen and the at least one other screen may be provided on a multi-screen configuration of a single device. An animated cursor may be used to emphasize portions of the subset of content items displayed on the presentation screen. The animated cursor may leave a fading trace indicating a previous location of the fading cursor. The animated cursor may be controllable by at least one of: a computer mouse and a touch device. At least one of the subset of content items shown on the presentation screen may include an external link and clicking on the external link may cause a corresponding item to be displayed on the presentation screen. The corresponding item may be opened using a native application for the corresponding item. Text may be enlarged and displayed in a uniform font prior to being displayed on the presentation screen. Colors applied to the text may be unsaturated and/or converted into a smaller palette. The presentation screen may be a screen of a mobile device. The mobile device mobile device may use an operating system selected from the group consisting of: iOS, Android OS, Windows Phone OS, Blackberry OS and mobile versions of Linux OS.

According further to the system described herein, computer software, provided in a non-transitory computer-readable medium, presents content. The software includes executable code that selects a subset of content items from a content collection, where at least some of the subset of content items includes a plurality of objects selected from the group of categories consisting of: text, images, web clips, HTML clips, audio clips, video clips, links to external web content, document attachments, and multimedia attachments and executable code that displays content items from the subset of content items on a presentation screen, where intelligent navigation facilitates scanning through objects included with each of the content items. The intelligent navigation may use a dedicated button, a keyboard shortcut and/or a multi-touch gesture for scanning through objects. The intelligent navigation may allow scrolling through objects by category. The software may also include executable code that automatically forms a first cover note having a first table of contents listing titles of at least a first portion of the subset of content items and corresponding links thereto. A presentation sequence for the content items may be directed by the first cover note in an order of selection of the content items. Clicking a link shown on the first cover note may cause a corresponding one of the content items to be opened. A second cover note, embedded in the first cover note, may be provided where the second cover note may include a second table of contents listing titles of at least a second portion of the subset of content items and corresponding links thereto, the second portion being different than the first portion. Each of the subset of content items that is edited while being displayed on the presentation screen may cause the presentation screen to be updated while being viewed. Editing functionality may be provided by at least one other device separate from a device controlling the presentation screen. Editing functionality may be provided by a plurality of other devices separate from the device controlling the presentation screen. Editing functionality may be provided by at least one other screen separate from the presentation screen. A presenter may control the at least one other screen. The presentation screen and the at least one other screen may be provided on a multi-screen configuration of a single device. An animated cursor may be used to emphasize portions of the subset of content items displayed on the presentation screen. The animated cursor may leave a fading trace indicating a previous location of the fading cursor. The animated cursor may be controllable by at least one of: a computer mouse and a touch device. At least one of the subset of content items shown on the presentation screen may include an external link and clicking on the external link may cause a corresponding item to be displayed on the presentation screen. The corresponding item may be opened using a native application for the corresponding item. Text may be enlarged and displayed in a uniform font prior to being displayed on the presentation screen. Colors applied to the text may be unsaturated and/or converted into a smaller palette. The presentation screen may be a screen of a mobile device. The mobile device mobile device may use an operating system selected from the group consisting of: iOS, Android OS, Windows Phone OS, Blackberry OS and mobile versions of Linux OS.

The proposed system automatically builds, displays and allows inline navigation and modification of presentations directly from entries of a content collection (hereinafter, notes) thus eliminating a need in standalone presentations and allowing presenters and viewers to concentrate on content.

Notes in a presentation may be reformatted to deliver high visual quality and to allow graphical differentiation between various content types. A dedicated navigation scheme within a presented note, including intelligent pagination, allows viewing of all note components, including text, images and attached documents, in large size and in a logical succession of the components.

A direct presentation from a content collection may include an individual note or a set of notes. Multiple notes may be selected individually by a presenter or may include all notes labeled by a selected tag or multiple tags, all notes in a selected notebook, and other filtered sets of notes, for example, all notes satisfying a search term or all notes taken in a certain geographical area, such as notes corresponding to a selected set of locations in an Evernote Atlas.

For direct presentations containing multiple notes, a Cover Page note—an enhanced table of contents—may be automatically built. The Cover Page note may include links to each note in a selected set and may also include a summary of a corresponding presentation, additional sections, etc. Intelligent navigation of a multi-note presentation may be provided where the system assists in scanning through notes and through embedded internal and external links, including external web pages.

Direct presentations may be instantly editable in multi-screen or multi-computer configurations where a presenter or other users with sufficient permissions may edit notes in a presentation; edited notes may be instantly updated and displayed with a minimal latency to meeting participants.

Some of the features of direct presentations from content collections are explained in more details below.

During initial formatting for presentation, the content of a note may be split into several layers: text, images, web and other HTML clips, audio and video clips and links, document and multimedia attachments, etc. Each layer may have formatting and rendering rules for the layer, for example:
Text size may be enlarged and displayed in a uniform font; colors applied to diverse text elements may be unsaturated or converted into a smaller palette (including grayscale) to provide consistent high quality views.
Images may be sorted by size; an image that is provided with pre-defined dimensions within a page may be displayed in an original size of the image; larger images may be scaled down to fit the dimensions of display zones; images may also be centered for better viewing quality.
Fragments of HTML text identified in notes by previous web page clipping or copying activities may be left without spatial reformatting to hint at an original source of the fragments.
Audio and video clips may be displayed as attachments without being replayed automatically; such replays may require an explicit instruction by a presenter.
Attached documents and multimedia files may be represented by title pages of the documents and files. In case of multi-page attachments, a multi-document frame may be displayed around a title page inviting a presenter to open the presentation by clicking on the title page.

Two different navigation modes may be provided for each individual note included in a direct presentation:
In a main mode, note content may be progressively scrolled down and up.
In a document view mode, invoked by clicking on an image or an attachment, only images and/or content of attachments may be displayed.

A special highlighting tool—a Laser Pointer—may be used for emphasizing portions of content of notes and external documents. The Laser Pointer may be an animated color cursor leaving a fading trace and quickly moving, like a shooting star, by a curved trajectory, in a direction of the content to which the presenter is pointing. The Laser Pointer may have customizable colors and may be controlled by a computer mouse or a touch device (clicking or tapping and holding may convert The Laser Pointer into a regular cursor for content manipulations).

Clicking links within presented notes may open linked objects, such as other notes, external web pages or other external documents. Linked notes and external web pages may be displayed in a same presentation view. Additionally or alternatively, a special control, such as a button, a multi-touch gesture or a keyboard shortcut, may allow opening external objects in a corresponding native applications, such as web browsers, PDF editors, office applications, etc., in order to facilitate operating these objects. For example, entering credentials to access protected content may be deferred to native applications.

Every time a set of notes is selected via direct user actions or as a result of filtering a content collection by tags, notebooks, search results, locations or other filters, a Cover Note may be instantly added to the collection by a single click, multi-touch gesture or by executing a keyboard shortcut. Initially, the Cover Note may include a table of contents, which has a listing of titles of selected notes and links each title to a respective note. A presenter may further edit a Cover Note to provide a presentation title, an abstract or summary, add sections, comments to note titles, etc.

A direct presentation does not require a Cover Note but, if a Cover Note has been built, the presentation may be directed by the Cover Note. Thus, starting a direct presentation with a Cover Note and clicking an embedded note link may open the corresponding note; after viewing the note and pressing a Next button (or a corresponding keyboard shortcut), the presentation may return to the Cover Note and may automatically progress to the next note link and highlight the link, inviting the user to open the next note in a presentation. This allows for a persistent and intuitive navigation interface whereby a dedicated button, keyboard shortcut (for example, pressing an Enter button) or a multi-touch gesture (say, a swipe to the right as a metaphor of the next action or item) may be used to progress through the whole multi-note presentation.

Direct presentations from content collections may also allow for multiple Cover Notes at different levels and may be link-driven. Every time a note link or an external link is opened by a presenter, the Next action may return the presentation to a note where the original link has resided and may progress to a next link and highlight. Obviously, the presenter may override such automatic link-driven presentation order and scroll notes or documents in an arbitrary order.

As Cover Notes for direct presentations accumulate, the Cover Notes may be stored by the system within content collections or may be stored separately; Cover Notes may be automatically augmented with presentation dates and may be associated with other events, such as scheduled meetings in individual or shared calendars. Additionally, Cover Notes may be systematically searched, archived by the system or purged when the Cover Notes are not needed anymore.

Editing direct presentations on-the-fly may be available in a multi-screen or a multi-device mode. In a multi-screen mode, the system may automatically recognize the presence of a local and an external screen and may, by a request of the presenter, designate a local screen for note editing. On an editing screen, a content collection may be opened in an editing mode; presented notes may be instantly modified by a presenter or by another authorized user; simultaneously, the presenter may have access to all presentation tools for navigation, highlighting and other instruments for controlling presentation flow on the external screen. Alternatively, in a multi-device mode, editing and presentation functions may be split between two or more devices, rather than between two screens, so that the presenter, individually or with help by other viewers, may edit notes on an appropriate device. Modified notes may appear in the presentation with a slight delay and may replace original notes. Collaborative editing of all or some of the notes in a presentation may also be available; collaborative editing may be partially or completely supervised by a presenter or may be completely unsupervised.

### BRIEF DESCRIPTION OF THE DRAWINGS

Embodiments of the system described herein will now be explained in more detail in accordance with the figures of the drawings, which are briefly described as follows.

FIG. 1 is a schematic illustration of content collection and direct presentation in a main mode, according to embodiments of the system described herein.

FIG. 2 schematically illustrates direct presentation in a document view mode, according to embodiments of the system described herein.

FIG. 3 is a schematic illustration of a Laser Pointer, according to embodiments of the system described herein.

FIGS. 4A and 4B illustrate creation and structure of a Cover Note, according to embodiments of the system described herein.

FIG. 5 is a schematic illustration of link-centric navigation of a multi-level presentation, according to embodiments of the system described herein.

FIG. 6 is a system flow diagram illustrating providing a presentation, according to embodiments of the system described herein.

### DETAILED DESCRIPTION OF VARIOUS EMBODIMENTS

The system described herein provides a mechanism for creating, organizing, rendering, viewing, navigating and modifying direct presentations of notes from content collections.

Flexible instant presentations save time for building formal presentations and allow presenters and viewers to focus on presented materials.

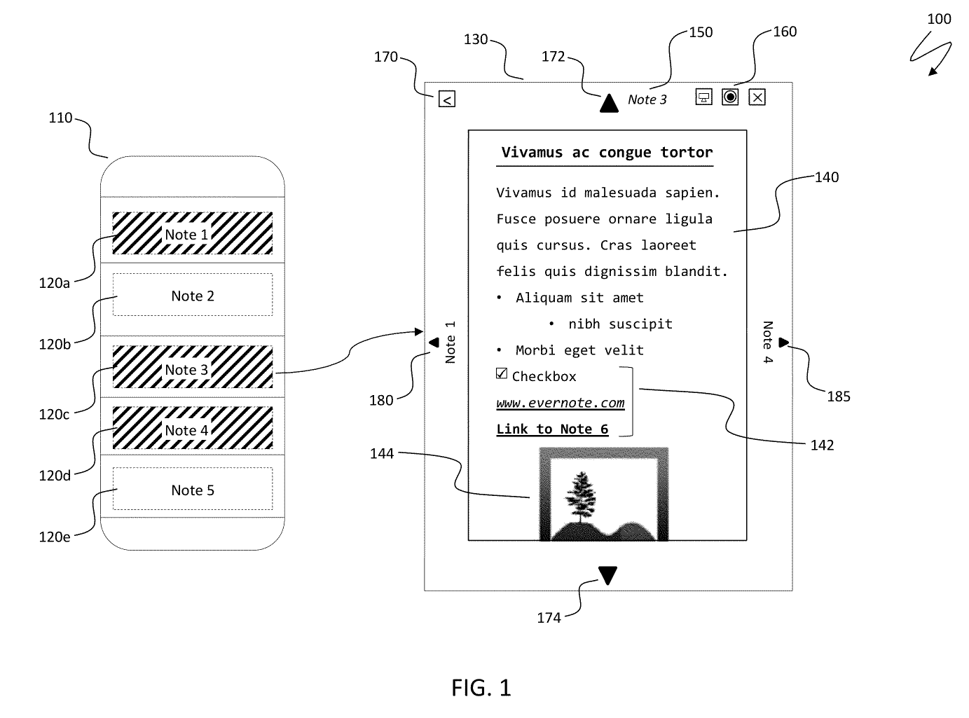

FIG. 1 is a schematic illustration 100 of a content collection and a direct presentation in a main mode. A content collection 110 is shown with five notes 120a-120d; three of the notes 120a, 120c, 120d are selected for an instant presentation and 120c is loaded into a presentation screen 130. Note content is formatted by segments: text 140 of the note 120c has been enlarged both in size and in line spacing; checkboxes and links 142 have been formatted differently from the main text to provide visual clues, and an image 144 has been centered. A title 150 of the note 120c is displayed in a top portion of the presentation screen 130, in line with a presentation toolbar 160 and navigation tools such as a back arrow 170 that returns the presentation to a previous screen. Scrolling buttons 172, 174 scroll contiguously through the note. Two other navigation buttons 180, 185 serve as Previous and Next buttons providing access to a previous note (the note 120a) and a following note (the note 120d).

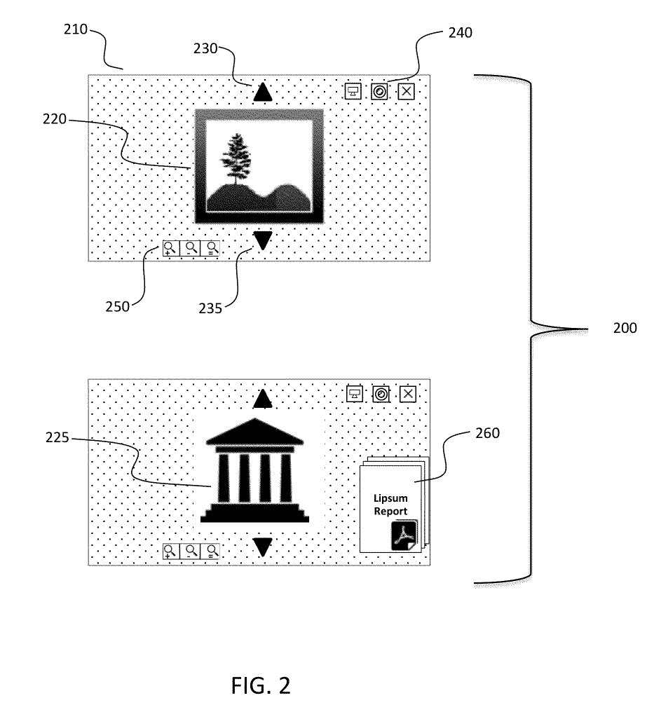

FIG. 2 is a schematic illustration 200 of a direct presentation in a document view mode. A presentation screen 210 shows images 220, 225 from a single chosen note switched into the document view mode. In the document view mode, navigation buttons 230, 235 scroll through images within a note. A presentation toolbar 240 is augmented with a zoom toolbar 250. Upon reaching a last image (the image 225 in FIG. 2), the system may display other documents and objects viewable in the document view mode. FIG. 2 shows another document that is a multi-page PDF report 260, which may be opened in the document view mode. Presenter options may include scrolling images, switching to scrolling other documents or closing the document view mode and returning to a main view of a presented note.

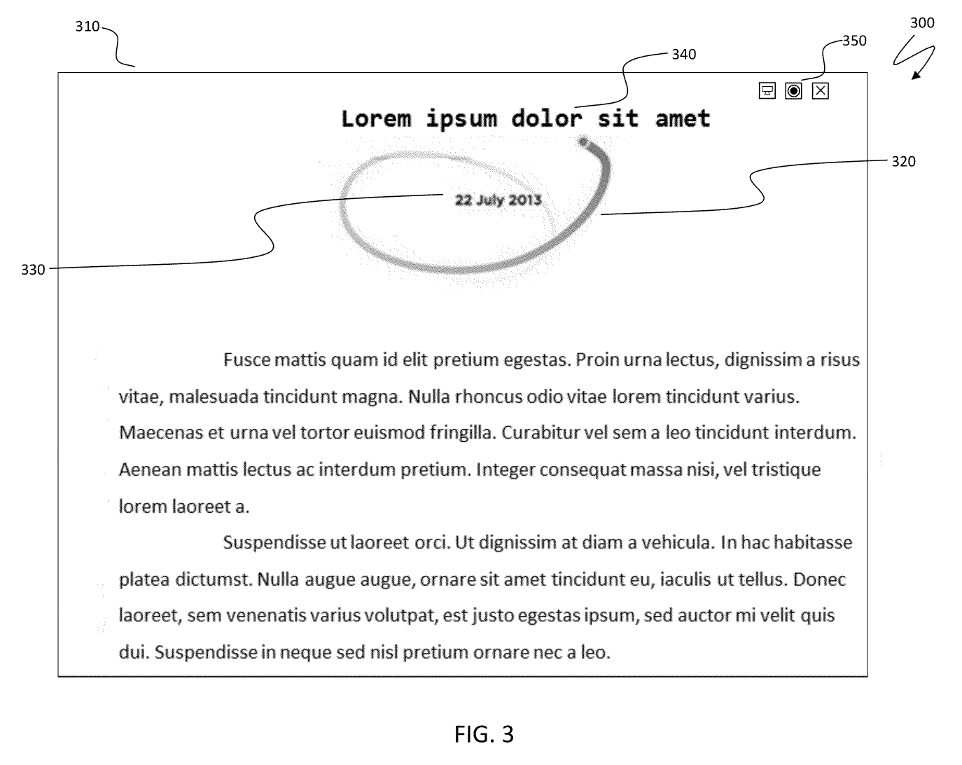

FIG. 3 is a schematic illustration 300 of a Laser Pointer. A presenter may navigate a presentation screen 310 with a mouse, a finger over a touch screen or a touchpad, a stylus or with an other navigational instrument. A fast moving animated cursor 320 with a fading tale (shown by a thinner portion of the cursor 320) moves in a direction of navigation, analogous to a shooting star. FIG. 3 shows highlighting two objects: first, the presenter highlights a date 330 by encircling the date 330 with the Laser Pointer cursor; next, the presenter moves the cursor toward a title 340 to highlight the title 340, as shown by a head portion of the cursor 320. A color of the cursor 320 may be changed using a Laser Pointer color picker 350.

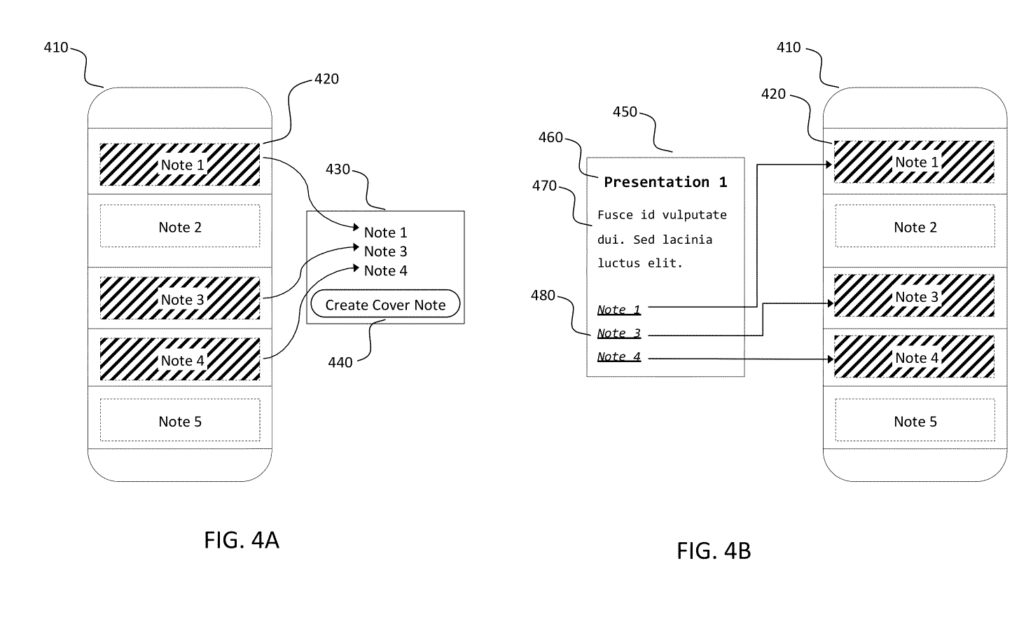

FIGS. 4A and 4B illustrate creation and structure of a Cover Note. A content collection 410 has several notes 420 selected by a presenter (Note 1, Note 3, Note 4). Note titles or thumbnails may be placed into a selection pane 430 to allow various operations over the selected notes (such as cutting, copying, deleting, merging, moving to another content collection, tagging, etc.). A dedicated button 440 may instantly create a Cover Note 450 associated with the selection. The Cover Note 450 may include a default presentation title 460 and a summary 470 (for example, “Cover Note for three notes created on <date+time>”), both editable by the presenter. The Cover Note 450 may also include a list of note titles 480 of all selected notes where each note title is linked to a respective note 420 of the content collection 420. Links are symbolically shown by italicizing and underlining note titles 480. Subsequently, starting a presentation with the Cover Note 450 allows for a seamless navigation of the presentation. In some embodiments, there may also be subordinate Cover Notes selected within a content collection.

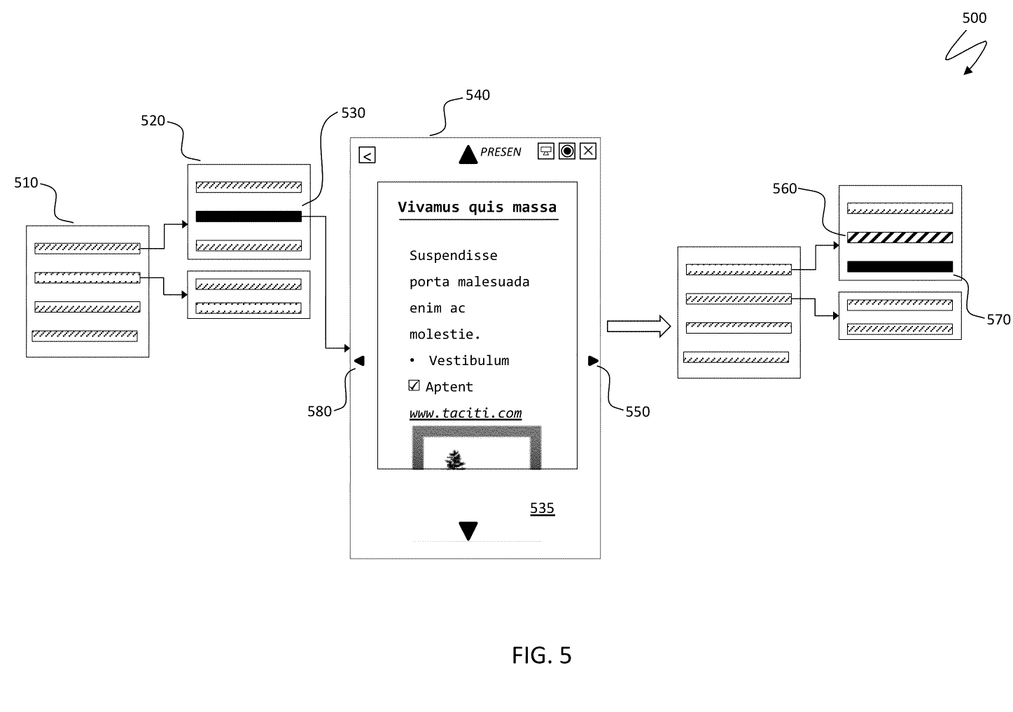

FIG. 5 is a schematic illustration 500 of a link-centric navigation of a multi-level presentation. A Cover Note 510 links to four notes, two of which include embedded links, as illustrated by a note 520. The note 520 includes three links; a currently active link 530 corresponds to a note 535 with a title “PRESEN” opened in a presentation screen 540. At the end of presenting content of the note 535 obtained via the link 530, the presenter may click a scrolling button 550 to go to a next note in the presentation. If the presenter has not altered a default presentation order, clicking the scrolling button 550 may cause the presentation to move to a next link 560 in the note 520, while the note 530 that was previously presented will be marked as a previous note 570 and may be recalled (at the time when the note 570 loaded by the link 560 is being presented) by pressing a Previous button 580.

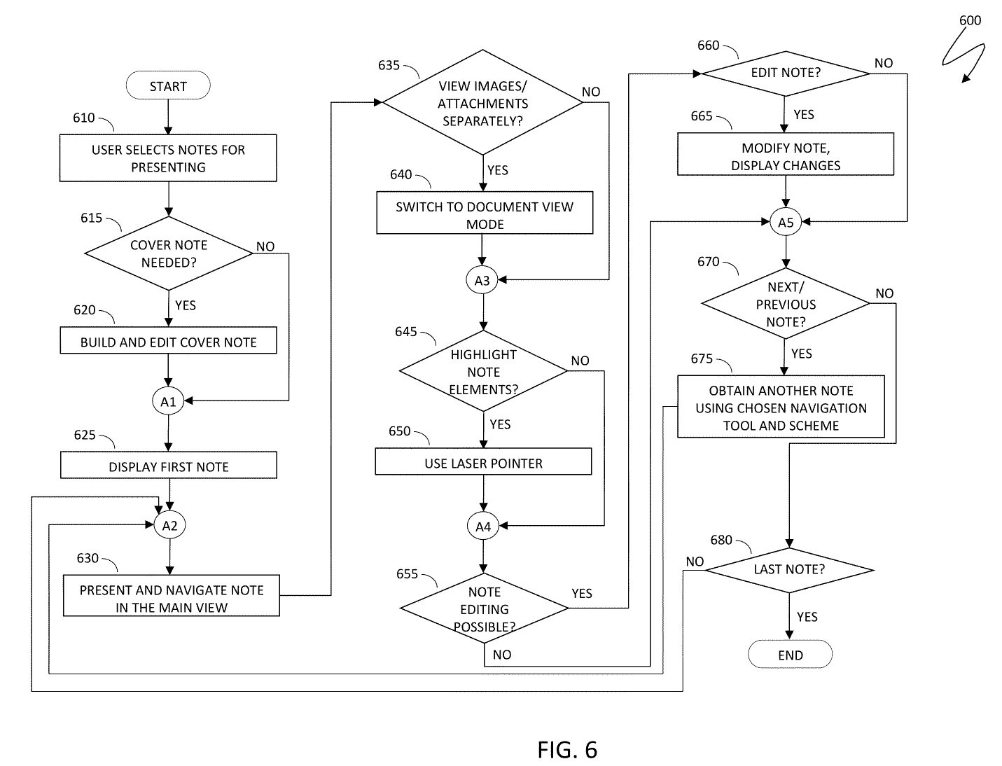

Referring to FIG. 6, a flow diagram 600 illustrates providing a presentation. Processing starts at a step 610 where a presenter selects one or more notes for presenting. After the step 610, processing proceeds to a test step 615, where it is determined whether a Cover Note for notes selected at the step 610 is needed. If so, processing proceeds to a step 620 where the system builds and the presenter may edit the Cover Note. After the step 620, processing proceeds to a step 625, where the system displays a first note either in an order caused by an initial selection or in an order corresponding to a Cover Note. Note that the step 625 can be independently reached from the test step 615 if the Cover Note is not needed.

After the step 625, processing proceeds to a step 630, where the presenter presents and navigates the note in a main view. After the step 630, processing proceeds to a test step 635, where it is determined whether there is a need to view images, attachments or other objects separately from the note. If so, processing proceeds to a step 640, where the system switches to a document view mode, as explained elsewhere herein (see, for example, FIG. 2 and the corresponding text). After the step 640, processing proceeds to a test step 645, where it is determined whether the presenter needs to highlight note elements for other participants of the presentation. Note that the step 645 may be independently reached from the test step 635 if it is determined that there is no need to view images or attachments separately.

If it is determined at the test step 645 that the presenter needs to highlight note elements, then processing proceeds to a step 650 where the presenter uses the Laser Pointer as needed for highlighting. After the step 650, processing proceeds to a test step 655, which also follows the test step 645 in case when there is no need to highlight note elements. At the test step 655, it is determined whether note editing is possible (various conditions for note editing on an editing screen or a separate device are explained elsewhere herein). If so, processing proceeds to a test step 660 where it is determined if the presented needs to edit the presentation. If so, processing proceeds to a step 665, where the presenter or other users modify the presentation and display changes.

After the step 665, processing proceeds to a test step 670, which may be independently reached from the test step 660 if there is no need to edit the presentation. At the test step 670, it is determined whether the presenter has pressed Next or Previous navigation buttons. If so, processing proceeds to a step 675 where the system obtains another note following the chosen navigation tool (Next/Previous) and a navigation scheme (for example, a link-centric scheme explained in connection with FIGS. 4, 5 or a plain scheme of selected note succession without a Cover Note and without following note links). After the step 675, processing proceeds back to the step 630 to start a new presentation cycle with the obtained note. If it is determined at the step 670 that the presenter did not press a Next/Previous note button, then processing proceeds to a test step 680 where it is determined whether the current note is the last note in the presentation. If so, processing is complete; otherwise, processing proceeds back to the step 630 to continue the presentation.

Various embodiments discussed herein may be combined with each other in appropriate combinations in connection with the system described herein. Additionally, in some instances, the order of steps in the flowcharts, flow diagrams and/or described flow processing may be modified, where appropriate. Subsequently, elements and areas of screen described in screen layouts may vary from the illustrations presented herein. Further, various aspects of the system described herein may be implemented using software, hardware, a combination of software and hardware and/or other computer-implemented modules or devices having the described features and performing the described functions.

Note that mobile device(s) capable of running the system described herein may include software that is pre-loaded with the device, installed from an app store, installed from a desktop (after possibly being pre-loaded thereon), installed from media such as a CD, DVD, etc., and/or downloaded from a Web site. The mobile device may use an operating system such as iOS, Android OS, Windows Phone OS, Blackberry OS and mobile versions of Linux OS.

Software implementations of the system described herein may include executable code that is stored in a computer readable medium and executed by one or more processors, including one or more processors of a desktop computer. The desktop computer may include software that is pre-loaded with the device, installed from an app store, installed from media such as a CD, DVD, etc., and/or downloaded from a Web site. The computer readable medium may be non-transitory and include a computer hard drive, ROM, RAM, flash memory, portable computer storage media such as a CD-ROM, a DVD-ROM, a flash drive, an SD card and/or other drive with, for example, a universal serial bus (USB) interface, and/or any other appropriate tangible or non-transitory computer readable medium or computer memory on which executable code may be stored and executed by a processor. The system described herein may be used in connection with any appropriate operating system.

Other embodiments of the invention will be apparent to those skilled in the art from a consideration of the specification or practice of the invention disclosed herein. It is intended that the specification and examples be considered as exemplary only, with the true scope and spirit of the invention being indicated by the following claims.

What is claimed is:

1. A method of presenting content, comprising:
selecting a subset of content items from a content collection, wherein at least some of the subset of content items includes a plurality of objects selected from the group of categories consisting of: text, images, web clips, HTML clips, audio clips, video clips, links to external web content, document attachments, and multimedia attachments; and
displaying content items from the subset of content items on a presentation screen, wherein intelligent navigation facilitates scanning through objects included with each of the content items.

2. A method, according to claim 1, wherein the intelligent navigation uses at least one of: a dedicated button, a keyboard shortcut and a multi-touch gesture for scanning through objects.

3. A method, according to claim 1, wherein the intelligent navigation allows scrolling through objects by category.

4. A method, according to claim 1, further comprising:
automatically forming a first cover note having a first table of contents listing titles of at least a first portion of the subset of content items and corresponding links thereto.

5. A method, according to claim 4, wherein a presentation sequence for the content items is directed by the first cover note in an order of selection of the content items.

6. A method, according to claim 5, wherein clicking a link shown on the first cover note causes a corresponding one of the content items to be opened.

7. A method, according to claim 4, wherein a second cover note, embedded in the first cover note, is provided and wherein the second cover note includes a second table of contents listing titles of at least a second portion of the subset of content items and corresponding links thereto, the second portion being different than the first portion.

8. A method, according to claim 1, wherein each of the subset of content items that is edited while being displayed on the presentation screen causes the presentation screen to be updated while being viewed.

9. A method, according to claim 8, wherein editing functionality is provided by at least one other device separate from a device controlling the presentation screen.

10. A method, according to claim 9, wherein editing functionality is provided by a plurality of other devices separate from the device controlling the presentation screen.

11. A method, according to claim 9, wherein editing functionality is provided by at least one other screen separate from the presentation screen.

12. A method, according to claim 11, wherein a presenter controls the at least one other screen.

13. A method, according to claim 11, wherein the presentation screen and the at least one other screen are provided on a multi-screen configuration of a single device.

14. A method, according to claim 1, wherein an animated cursor is used to emphasize portions of the subset of content items displayed on the presentation screen.

15. A method, according to claim 14, wherein the animated cursor leaves a fading trace indicating a previous location of the fading cursor.

16. A method, according to claim 14, wherein the animated cursor is controllable by at least one of: a computer mouse and a touch device.

17. A method, according to claim 1, wherein at least one of the subset of content items shown on the presentation screen includes an external link and clicking on the external link causes a corresponding item to be displayed on the presentation screen.

18. A method, according to claim 17, wherein the corresponding item is opened using a native application for the corresponding item.

19. A method, according to claim 1, wherein text is enlarged and displayed in a uniform font prior to being displayed on the presentation screen.

20. A method, according to claim 19, wherein colors applied to the text are one of: unsaturated and converted into a smaller palette.

21. A method, according to claim 1, wherein the presentation screen is a screen of a mobile device.

22. A method, according to claim 21, wherein the mobile device mobile device uses an operating system selected from the group consisting of: iOS, Android OS, Windows Phone OS, Blackberry OS and mobile versions of Linux OS.

23. Computer software, provided in a non-transitory computer-readable medium, that presents content, the software comprising:
executable code that selects a subset of content items from a content collection, wherein at least some of the subset of content items includes a plurality of objects selected from the group of categories consisting of: text, images, web clips, HTML clips, audio clips, video clips, links to external web content, document attachments, and multimedia attachments; and
executable code that displays content items from the subset of content items on a presentation screen, wherein intelligent navigation facilitates scanning through objects included with each of the content items.

24. Computer software, according to claim 22, wherein the intelligent navigation uses at least one of: a dedicated button, a keyboard shortcut and a multi-touch gesture for scanning through objects.

25. Computer software, according to claim 23, wherein the intelligent navigation allows scrolling through objects by category.

26. Computer software, according to claim 23, further comprising:
executable code that automatically forms a first cover note having a first table of contents listing titles of at least a first portion of the subset of content items and corresponding links thereto.

27. Computer software, according to claim 26, wherein a presentation sequence for the content items is directed by the first cover note in an order of selection of the content items.

28. Computer software, according to claim 27, wherein clicking a link shown on the first cover note causes a corresponding one of the content items to be opened.

29. Computer software, according to claim 26, wherein a second cover note, embedded in the first cover note, is provided and wherein the second cover note includes a second table of contents listing titles of at least a second portion of the subset of content items and corresponding links thereto, the second portion being different than the first portion.

30. Computer software, according to claim 23, wherein each of the subset of content items that is edited while being displayed on the presentation screen causes the presentation screen to be updated while being viewed.

31. Computer software, according to claim 30, wherein editing functionality is provided by at least one other device separate from a device controlling the presentation screen.

32. Computer software, according to claim 31, wherein editing functionality is provided by a plurality of other devices separate from the device controlling the presentation screen.

33. Computer software, according to claim 31, wherein editing functionality is provided by at least one other screen separate from the presentation screen.

34. Computer software, according to claim 33, wherein a presenter controls the at least one other screen.

35. Computer software, according to claim 33, wherein the presentation screen and the at least one other screen are provided on a multi-screen configuration of a single device.

36. Computer software, according to claim 23, wherein an animated cursor is used to emphasize portions of the subset of content items displayed on the presentation screen.

37. Computer software, according to claim 36, wherein the animated cursor leaves a fading trace indicating a previous location of the fading cursor.

38. Computer software, according to claim 36, wherein the animated cursor is controllable by at least one of: a computer mouse and a touch device.

39. Computer software, according to claim 23, wherein at least one of the subset of content items shown on the presentation screen includes an external link and clicking on the external link causes a corresponding item to be displayed on the presentation screen.

40. Computer software, according to claim 39, wherein the corresponding item is opened using a native application for the corresponding item.

41. Computer software, according to claim 23, wherein text is enlarged and displayed in a uniform font prior to being displayed on the presentation screen.

42. Computer software, according to claim 41, wherein colors applied to the text are one of: unsaturated and converted into a smaller palette.

43. Computer software, according to claim 23, wherein the presentation screen is a screen of a mobile device.

44. Computer software, according to claim 43, wherein the mobile device mobile device uses an operating system selected from the group consisting of: iOS, Android OS, Windows Phone OS, Blackberry OS and mobile versions of Linux OS.
